(19) United States
(12) Patent Application Publication
(10) Pub. No.: US 2015/0022677 A1
(43) Pub. Date: Jan. 22, 2015

(54) SYSTEM AND METHOD FOR EFFICIENT POST-PROCESSING VIDEO STABILIZATION WITH CAMERA PATH LINEARIZATION

(71) Applicant: QUALCOMM Incorporated, San Diego, CA (US)

(72) Inventors: Kai Guo, San Diego, CA (US); Shu Xiao, San Diego, CA (US); Prasanjit Panda, San Diego, CA (US)

(21) Appl. No.: 13/943,145

(22) Filed: Jul. 16, 2013

(51) Int. Cl. H04N 5/232

(52) U.S. Cl. CPC H04N 5/23267; H04N 5/23254
USPC 348/208.1

(57) ABSTRACT

Described herein are methods, systems, and apparatus to process video images to remove jitteriness due to hand shake. In one aspect, a camera is configured to capture raw video composed of a series of successive image frames of a scene of interest. A processor is configured to receive the image frames, estimate a global camera motion from successive frames, stabilize the camera motion by establishing an upper bound and a lower bound of the global camera motion and smoothing the curve of camera motion between the upper and lower bounds, and upsample the resulting stabilized video frames to produce a smooth video.

### BACKGROUND

1. Field of the Invention

The present embodiments relate to imaging devices, and in particular, to systems and methods for efficient post-processing video stabilization with camera path linearization.

2. Description of the Related Art

Video stabilization is an important video enhancement technology that seeks to remove undesired shaky motion and create stable versions of videos. Often, videos captured from hand-held cameras suffer from a significant amount of unexpected image motion caused by unintentional hand shake. With the growing popularity of portable camcorders and mobile phones, there are greater demands for video stabilization. Although many portable camcorders are equipped with optical stabilization systems, these systems typically dampen high frequency jittery movements but are not able to remove low frequency hand shake. Furthermore, unlike larger, dedicated video cameras, small electronic devices typically lack mechanical or optical mechanisms to reduce jittery video motion from hand shakiness or other causes.

Known digital video image stabilization techniques are computationally expensive. Therefore, a process that can synthesize a new image sequence from a stabilized camera trajectory with low computational complexity and low memory requirements would be desired.

### SUMMARY

Aspects of the disclosure relate to systems and methods for post-processing video stabilization with camera path linearization. Instead of using a complicated linear programming optimization method, a straightforward piece-wise linear curving fitting is disclosed below, which provides similar visual results and a much faster implementation (in some aspects, about >100×). In some aspects, the method includes the steps of estimating the camera motion, smoothing the camera path using linear functions, and performing image compensation to upsample the image to the original image resolution. In some aspects, this process can be applied to any video without prior knowledge of the camera or the scene. The process also maintains the original camera path by following and linearizing the original camera path. Additionally, the process can effectively stabilize videos with low computational complexity and low memory requirement.

In one aspect, a system for processing video images includes a camera configured to capture raw video composed of a series of successive image frames of a scene of interest and a processor configured to receive the image frames, estimate a global camera motion from successive frames, stabilize the camera motion by establishing an upper bound and a lower bound of the global camera motion and smoothing the curve of camera motion between the upper and lower bounds, and upsample the resulting stabilized video frames.

In another aspect, a method for processing video images includes receiving raw video composed of a series of successive image frames of a scene of interest, estimating a global camera motion from successive frames, establishing an upper and lower bound of the global camera motion by applying a cropping window to a first frame, smoothing the curve of camera motion between the upper and lower bound to obtain a smooth camera path, applying the cropping window to successive frames along the smooth camera path to obtain stabilized image frames, and upsampling the resulting stabilized image frames.

In yet another aspect, an apparatus for processing video images includes means for capturing raw video composed of a series of successive image frames of a scene of interest, means for estimating a global camera motion from successive frames, means for establishing an upper and lower bound of the global camera motion by applying a cropping window to a first frame, means for smoothing the curve of camera motion between the upper and lower bound to obtain a smooth camera path, means for applying the cropping window to successive frames along the smooth camera path to obtain stabilized image frames, and means for upsampling the resulting stabilized image frames.

In another aspect, a system for processing video images includes a camera configured to capture raw video composed of a series of successive image frames of a scene of interest and a control module. The control module may be configured to receive the raw video image frames, estimate a global camera motion from successive frames by extracting common features from the series of images, correlating the features in the series of images, and estimating a global camera motion by tracking the movement of the features by accumulating pairwise global motion vectors, stabilize the camera motion by establishing an upper bound and a lower bound of the global camera motion and smoothing the curve of camera motion between the upper and lower bounds, and upsample the resulting stabilized video frames.

In yet another aspect, a non-transitory, computer readable medium may include instructions that when executed by a processor cause the processor to perform a method of processing video images. The method may include receiving raw video composed of a series of successive image frames of a scene of interest, estimating a global camera motion from successive frames, establishing an upper and lower bound of the global camera motion by applying a cropping window to a first frame, smoothing the curve of camera motion between the upper and lower bound to obtain a smooth camera path, applying the cropping window to successive frames along the smooth camera path to obtain stabilized image frames, and upsampling the resulting stabilized image frames.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram depicting a system implementing some operative elements of video post-processing.

FIG. 2 is a flow chart illustrating a process for video image stabilization.

FIG. 3 illustrates a process for estimating the camera motion, according to one embodiment.

FIG. 4 illustrates a cropped image, according to one embodiment.

FIG. 5 illustrates a graphical representation of the camera motion and the upper and lower bounds of camera motion, according to one embodiment.

FIG. 6 illustrates a graphical representation of an approximate camera motion trajectory, according to one embodiment.

FIG. 7 illustrates a graphical representation of a smoothed camera motion trajectory, according to one embodiment.

FIG. 8 is a flow chart illustrating a process for camera path smoothing as part of an image stabilization process.

### DETAILED DESCRIPTION

Implementations disclosed herein provide systems and methods for efficiently stabilizing video captured by a digital device. Embodiments relate to digital devices that include post-processing video stabilization that is performed after a video has been captured and that result in an improved video with reduced jitter. As discussed below, these methods and systems may have low computational complexity and memory requirements, thus being able to be performed faster than prior systems.

Embodiments relate to a system that first tracks corners of an image across multiple consecutive frames. Corners of objects within a captured image frame can be tracked more easily than other portions of an image because they generally have unique features that remain consistent in the multiple frames. For example, the corner of a building may remain easily identifiable in adjacent image frames, whereas portions of a sky or cloud may not as easily be tracked. Once the correspondence between multiple image frames has been established by tracking corners of objects within the frames, the system estimates the global motion between the frames. The system can then draw a camera path by accumulating the pairwise global motion vectors between the captured image frames.

To find a smooth camera path that removes the camera jitter and stabilizes the image, embodiments select a cropped window at the center of the image wherein all of the captured images include the cropped window. As can be imagined, if the camera is being shaken during video capture, portions at the top, bottom and sides of each frame may not appear in each captured frame. Thus, a building on the very right edge of a scene may not appear in every frame if the camera is panned left a little bit as the camera is being jittered. Thus, a cropped window is first selected which includes pixels that appear in every image frame under analysis. The system can then find the piecewise constant functions of the motion vectors between each frame.

In some embodiments, the system uses linear functions as connectors to smooth the transitions between adjacent constant functions. This will be explained in more detail below. A smoothed path of motion vectors for the cropped image area can then be determined which can be used to generate a smoothed, jitter-reduced, display of the captured video.

In some aspects, post-processing video stabilization can synthesize a new image sequence for the stabilized camera trajectory. The method can include the steps of camera motion estimation, camera path smoothing, and image compensation.

Embodiments may be implemented in System-on-Chip (SoC) or external hardware, software, firmware, or any combination thereof. Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

### System Overview

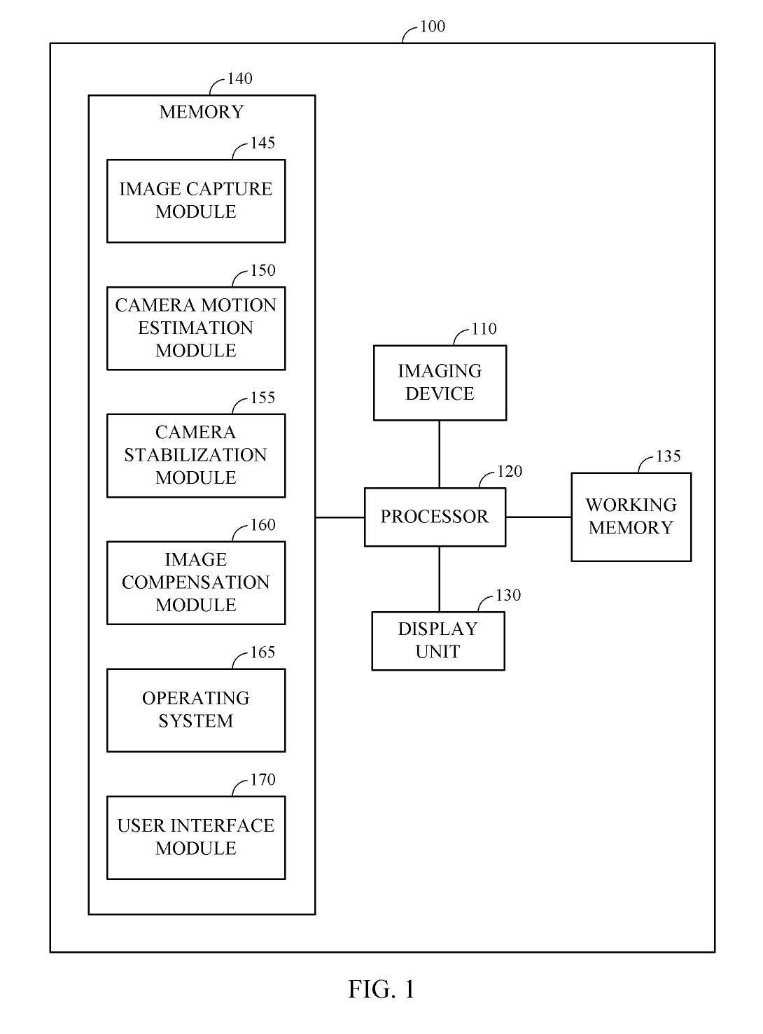

FIG. 1 illustrates one implementation of an image stabilization system 100 capable of estimating the camera path and smoothing the camera motion to account for jitteriness due to hand shake. The illustrated embodiment is not meant to be limitative and the system 100 may include a variety of other components as required for other functions.

The image stabilization system 100 may include an imaging device 110 and a display unit 130. Certain embodiments of display unit 130 may be any flat panel display technology, such as an LED, LCD, plasma, or projection screen. Display unit 130 may be coupled to the processor 120 for receiving information for visual display to a user. Such information may include, but is not limited to, visual representations of files stored in a memory location, software applications installed on the processor 120, user interfaces, and network-accessible content objects.

Imaging device 110 may employ one or a combination of imaging sensors. The image stabilization system 100 can further include a processor 120 linked to the imaging device 110. A working memory 135, electronic display 130, and program memory 140 are also in communication with processor 120. The image stabilization system 100 may be a stationary device such as a desktop personal computer or it may be a mobile device, such as a tablet, laptop computer, or cellular telephone.

Processor 120 may be a general purpose processing unit or it may be a processor specially designed for imaging application. As shown, the processor 120 is connected to program memory 140 and a working memory 135. In the illustrated embodiment, the program memory 140 stores an image capture module 145, a camera motion estimation module 150, a camera stabilization module 155, an image compensation module 160, operating system 165, and a user interface module 170. These modules may include instructions that configure the processor 120 to perform various image processing and device management tasks. Program memory 140 can be any suitable computer-readable storage medium, such as a non-transitory storage medium. Working memory 135 may be used by processor 120 to store a working set of processor instructions contained in the modules of memory 140. Alternatively, working memory 135 may also be used by processor 120 to store dynamic data created during the operation of image stabilization system 100.

As mentioned above, the processor 120 is configured by several modules stored in the memory 140. Imaging capture module 145 includes instructions that configure the processor 120 to obtain video images from the imaging device. Therefore, processor 120, along with image capture module 145 and imaging device 110, represent one means for obtaining raw video data composed of a series of successive image frames of a scene of interest. The camera motion estimation module 150 includes instructions that configure the processor 120 to estimate the imaging device's path of motion. Therefore, processor 120, along with camera motion estimation module 150 and working memory 135, represent one means for estimating a global camera motion from successive frames.

Memory 140 also contains camera stabilization module 155. The camera stabilization module 155 includes instructions that configure the processor 120 to stabilize the camera motion and smooth the curve of camera motion. Therefore, processor 120, along with camera stabilization nodule 155 and working memory 135, represent one means for stabilizing the camera motion by establishing an upper bound and a lower bound of the global camera motion and smoothing the curve of camera motion between the upper and lower bounds.

Image compensation module 160 is also contained within memory 140. The image compensation module 160 includes instructions that configure the processor 120 to move a cropped window in successive frames based on the smooth camera path and upsample each cropped image to original resolution. Therefore, processor 120, along with image compensation module 160 and working memory 135, represent one means for stabilizing the image frames and upsampling the stabilized image frames.

Memory 140 also contains user interface module 170. The user interface module 170 includes instructions that configure the processor 120 to provide a collection of on-display objects and soft controls that allow the user to interact with the device. The user interface module 170 also allows applications to interact with the rest of the system in a uniform, abstracted way. Operating system 165 configures the processor 120 to manage the memory and processing resources of system 100. For example, operating system 165 may include device drivers to manage hardware resources such as the electronic display 130 or imaging device 110. Therefore, in some embodiments, instructions contained in the camera motion estimation module 150 and camera stabilization module 155 may not interact with these hardware resources directly, but instead interact through standard subroutines or APIs located in operating system 165. Instructions within operating system 165 may then interact directly with these hardware components.

Although FIG. 1 depicts a device comprising separate components to include a processor, two imaging sensors, electronic display, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 1 illustrates two memory components, including memory component 140 comprising several modules and a separate memory 135 comprising a working memory, one with skill in the art would recognize several embodiments utilizing different memory architectures. For example, a design may utilize ROM or static RAM memory for the storage of processor instructions implementing the modules contained in memory 140. The processor instructions may then be loaded into RAM to facilitate execution by the processor. For example, working memory 135 may be a RAM memory, with instructions loaded into working memory 135 before execution by the processor 120.

### Method Overview

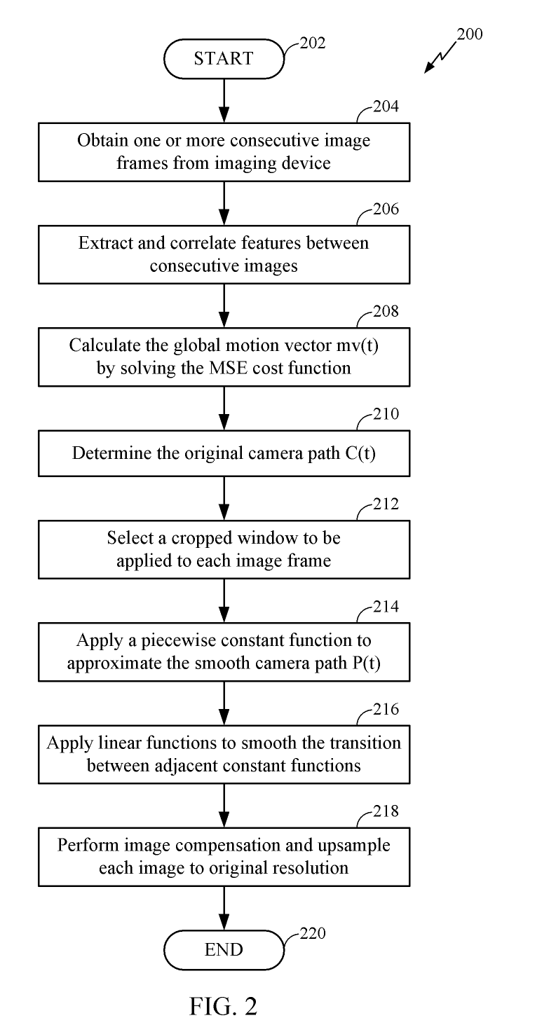

FIG. 2 illustrates a flowchart of an example method of efficient post-processing video stabilization in accordance with aspects of the disclosure. As illustrated in FIG. 2, the method 200 may begin by obtaining one or more consecutive video frames from a camera at block 204. The method proceeds by extracting and correlating features between consecutive images, as shown in block 206. These features may include object corners identified within the image, such as building corners. Any feature-based extraction method may be used, including Shi-Tomasi, Harris corner, Scale-Invariant Feature Transform (SIFT), and Speed-Up Robust Features (SURF). Additionally, feature correlation or correspondence may be performed by a number of methods, including Lucas Kanade, Horn-Schunck, Buxton-Buxton, and Black-Jepson.

Next, as shown in block 208, the global motion vector mv(t) can be estimated to determine the camera path. In some aspects, a translational model between two successive frames may be used to estimate the camera's path of motion. The camera's path may be drawn by accumulating pairwise global motion vectors. In one example, when frame t and frame t+1 come into the memory, corner detection is performed on frame t. An optical flow method can help track corners from frame t to t+1 and obtain N corresponding corner pairs: (p1, q1), (p2, q2), . . . , (pN, qN). Then the global motion vector mv(t) can be computed by solving the MSE cost function:

mv(t)=argminᵥΣᵢ₌₁^{N}[v−(qᵢ−pᵢ)]² Equation 1

After calculating the global motion vector, the camera path C(t) may be determined in block 210. Given mv(t), the camera path C(t) may be expressed as:

$$C ( t ) = {\sum }_{i = 1}^{t} mv ( i ) \qquad Equation 2$$

After calculating the camera path C(t), the process 200 transitions to block 212 where a cropped window is applied to each image frame. This cropped window includes the features extracted and correlated from each frame. The process 200 then transitions to block 214 wherein a piecewise constant function is applied to approximate the original camera path C(t). Once the camera path has been determined, a smooth camera path P(t) is found that removes the jitteriness of the original camera path C(t) but still follows the low-frequency trajectory of C(t). Following this step, linear functions may be applied to smooth the transition between adjacent constant functions. The cropped window may be moved through each consecutive image along the smoothed camera path to remove jitter.

After the camera path has been smoothed, each cropped image may be upsampled to the image's original resolution (W, H) as shown in block 218. Once each image has been upsampled to its original resolution, process 200 transitions to block 220 and ends.

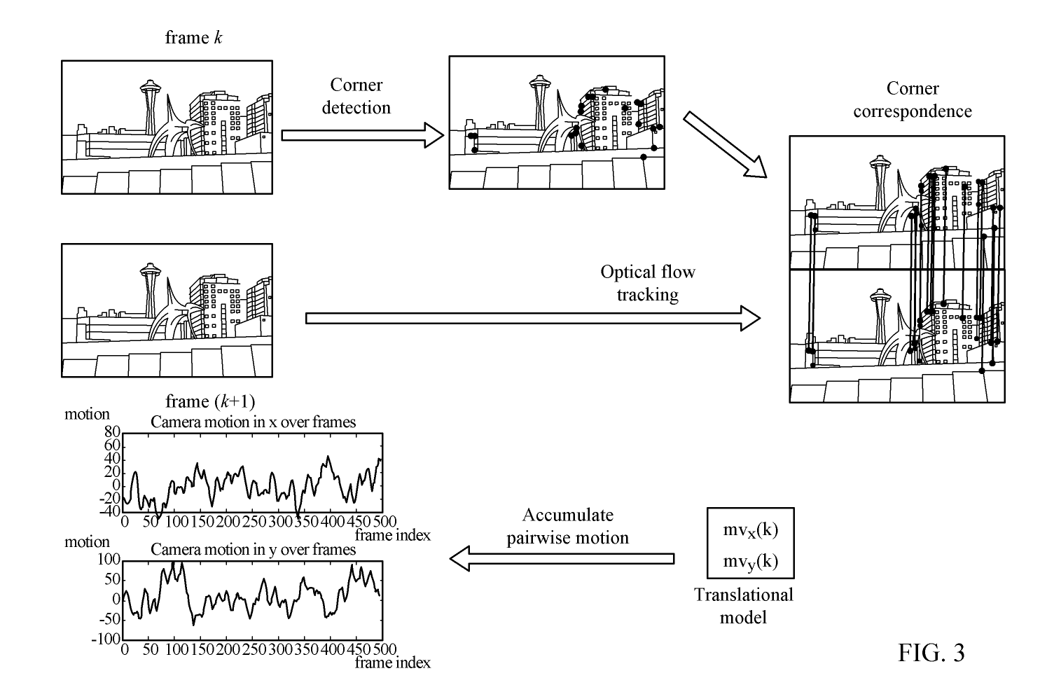

FIG. 3 illustrates a process of estimating the global motion between adjacent frames to determine the original camera path of motion. As discussed above, in one aspect of post-processing video stabilization, one step is to estimate the global motion between adjacent frames. In some aspects, a feature-based approach may be used in which features from a video frame are extracted and correlated between successive frames in order to estimate the camera's path of motion.

Block motion vectors (BMVs) between successive frames may also be used to track motion vectors between frames to replace corner detection and correspondence. BMVs are much denser than corners because each 8×8 block of pixels has one BMV. The BMVs indicate the correspondence of 8×8 blocks between adjacent frames. Similarly, Equation 1 can be used to estimate the global motion vector. It is worthwhile to point out that some BMVs are not reliable, especially those 8×8 blocks with little texture, such as sky or white board. Thus, it is critical to remove the BMVs of those low-texture blocks. To remove the unreliable BMVs, the pixel variance of each 8×8 block is computed. If the variance is less than a threshold (in some embodiments, less than 3000), the BMV of this block is removed. The advantage of using BMVs is that BMVs can be obtained from the video HW encoder in real time (30 fps for HD video). Therefore, the speed of getting BMVs is usually much faster than corner detection and correspondence.

FIG. 3 illustrates that features from a first video frame k are selected. These features are then tracked through each successive frame. In some embodiments, the features could be tracked using optical flow tracking. A translational model between two successive frames may be used to estimate the camera's path of motion. This camera path C(t) may then be smoothed as is discussed in greater detail below.

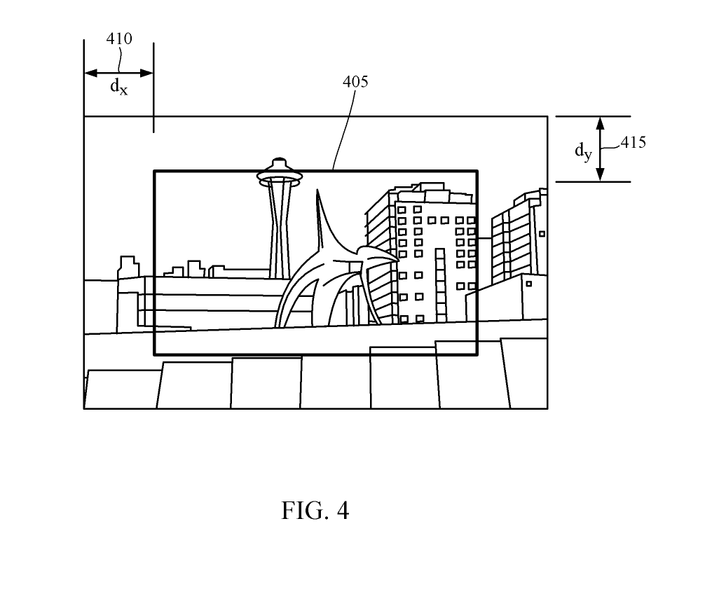

In general, video stabilization involves motion compensation that produces missing image content, i.e., pixels which were not originally observed in a frame. This problem is usually handled by trimming the video to keep the portion that appears in all frames. A cropped window centered in the first frame may be selected, as shown in FIG. 4. This window moves along the smooth camera path P(t). An upper and lower boundary of the camera path is determined from the size of the cropped window.

The upper and lower bounds are shown in FIG. 4. The cropped window 405 surrounds the focus area of the image. The size and shape of the cropped window 405 may be an adjustable setting or a fixed setting. In some embodiments, the cropping window is defined as 10% on each side of the image. For example, if the original size of the image is W×H, then the cropped size of the image is 0.8W×0.8H. In one embodiment, 10% is chosen as the cropping window because, if the cropping percentage is too small (the cropping window is too large), image stabilization will be limited; if the cropping percentage is too large (the cropping window is too small), there is too much image resolution loss. Thus, approximately 10% is one tradeoff between stabilization capability and retaining acceptable image resolution. Of course, cropping windows of other sizes, such as 5, 6, 7, 8, 9 percent, or 11, 12, 13, 14, 15 percent or other values are also within the scope of certain embodiments.

The cropped window 405 and the edges of the image define a distance dₓ 410 and a distance d_{y} 415. Given the size of the window, the maximum possible camera motion vector is d=(dₓ, d_{y}). The size of the cropped window 405 is therefore (W−2dx, H−2dy), where W and H are the width and height of the image frame. Therefore, the difference between the smooth camera path and the original camera path is less than or equal to d.

|P(t)−C(t)|≦d Equation 3

The upper and lower bounds UB(t) and LB(t) may be expressed as shown in Equation 4.

UB(t)=C(t)+d, LB(t)=C(t)−d. Equation 4

Therefore, the smooth camera path, P(t), should lie in the range of [LB(t), UB(t)].

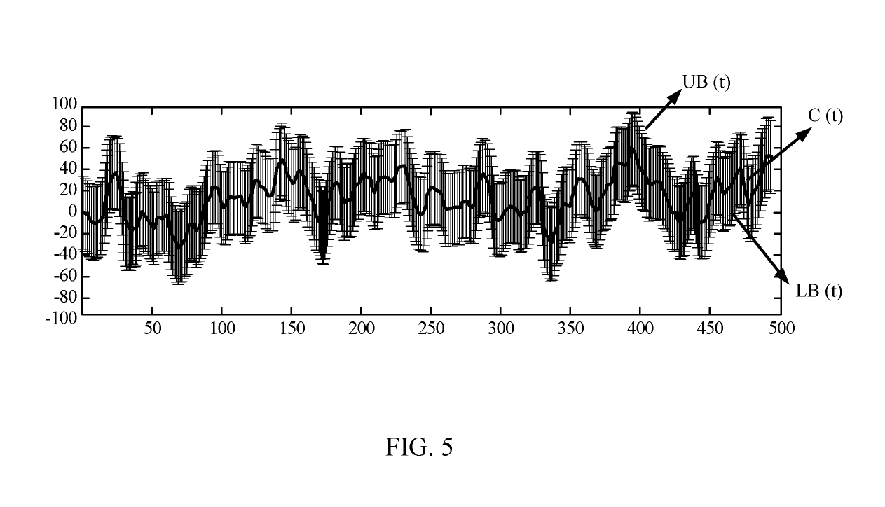

In some embodiments, a piecewise constant function may be used as a first iteration to approximate the camera path. Linear functions may then be used as connectors to smooth the transition between adjacent constant functions. FIG. 5 illustrates an example of a camera's raw path of motion, C(t), and the upper and lower bounds on the camera motion. The upper and lower bounds UB(t) and LB(t) define an enveloping area surrounding the raw path of motion C(t). The upper and lower bounds can be adjusted based on the size of the bounding box surrounding the image, as shown in FIG. 4.

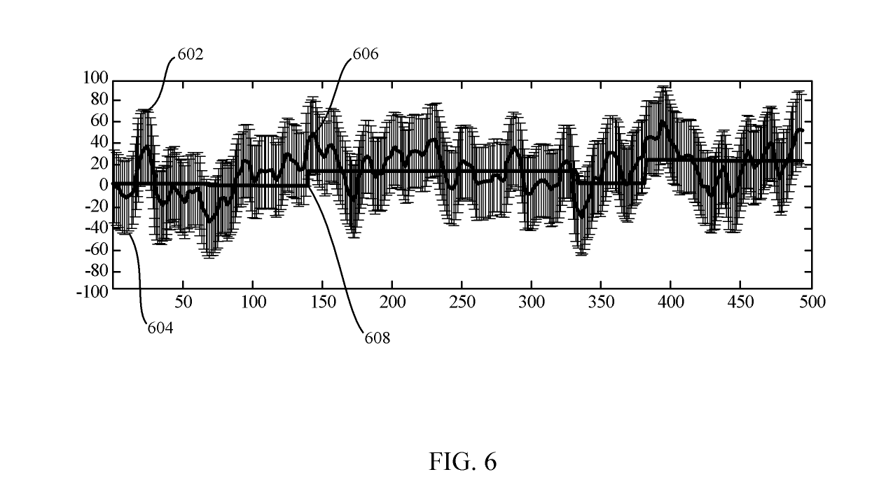

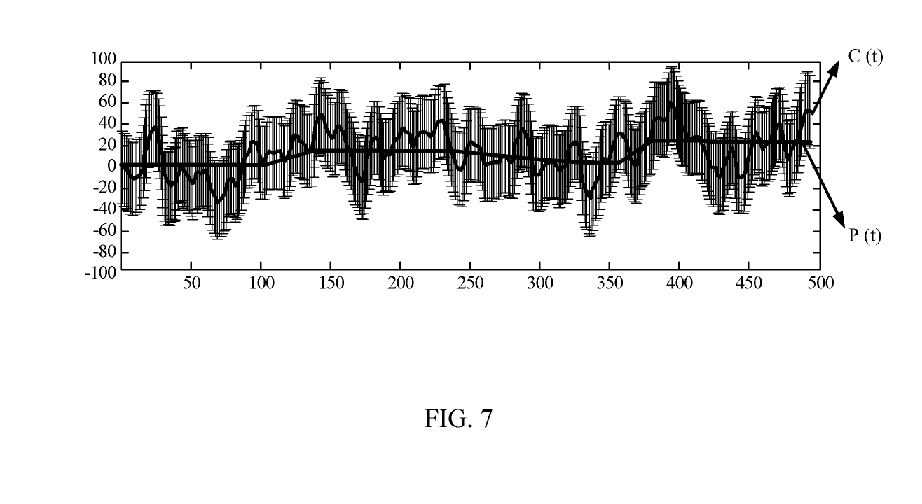

As illustrated in FIG. 6, the smooth camera path P(t) will also lie within the upper and lower bounds UB(t) and LB(t). In FIG. 6, the upper bound 602 and the lower bound 604 surround the original camera path C(t) 606. The smooth camera path 608 is shown as a piecewise linear function. As shown in this figure, the constant functions adapt to the low-frequency trajectory of the original camera path C(t). However, there are discontinuous gaps between adjacent constant functions. Linear functions may be used as connectors to smooth the transition between the adjacent constant functions. Linear functions indicate that the camera moves with a constant velocity. A linear function can be easily determined by selecting a starting point from the first constant function and an ending point from the second constant function. Any starting point and any ending point may be selected. In one embodiment, the starting point lies in the middle of the first constant function and the ending point is the initial point of the second constant function. In other embodiments, a starting point anywhere along the first constant function may be selected. A smooth camera path P(t) with linear functions connecting the constant functions is shown in FIG. 7.

Once the camera path has been smoothed, each frame can be compensated using the motion vector P(t)-C(t). As discussed above, the maximum possible motion vector is d=(dₓ, d_{y}) and the cropped window size is (W−2dx, H−2dy), where W and H are image width and height. The cropped window may be centered in the first frame. The cropped window then moves through the subsequent frames based on the smooth camera path P(t), which is used to crop each frame. Finally, each cropped image is upsampled to the original resolution.

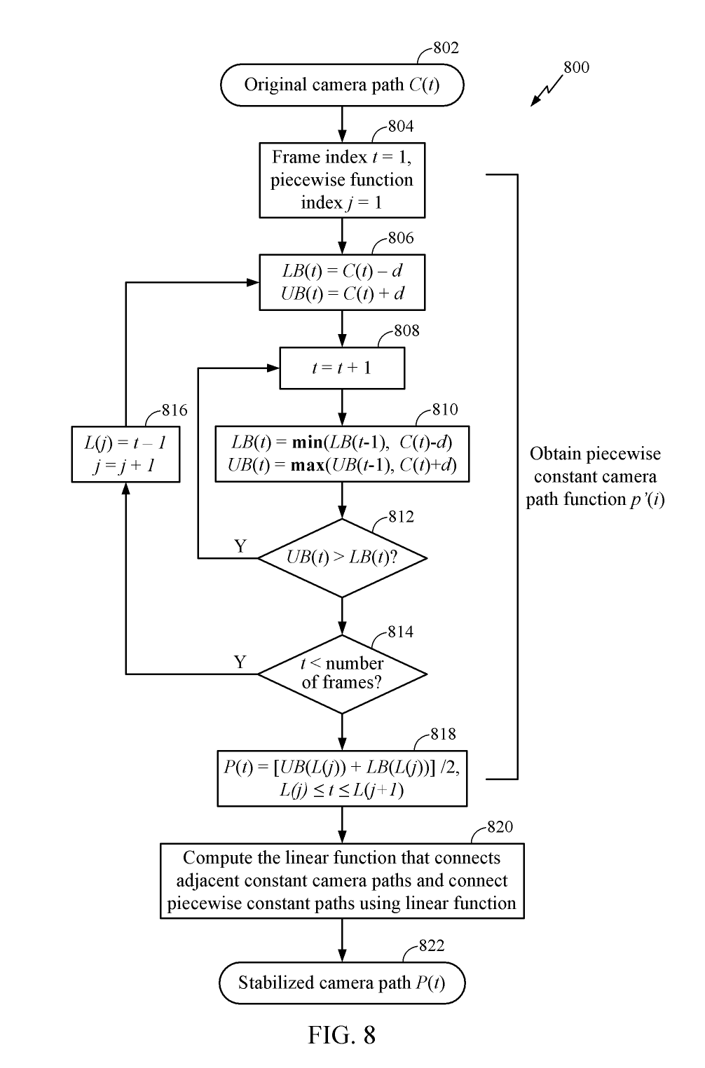

A flowchart illustrating one embodiment of a camera path smoothing process 800 is shown in FIG. 8. Provided with the original camera path C(t) in block 802, process 800 transitions to block 804 where each frame is indexed with the frame index t=1 and the piecewise function index j=1 are set. Process 800 then transitions to block 806 wherein the lower bound LB(t) and the upper bound UB(t) of the camera's path are determined, based on the maximum possible motion vector d=(dₓ, d_{y}) determined from the cropped window. LB(t) and UB(t) may be expressed as:

LB(t)=C(t)−d Equation 5

UB(t)=C(t)+d Equation 6

Process 800 then transitions to block 808 in which the frame index is increased by one. The process continues to block 810 in which the lower bound and upper bound are further calculated as:

LB(t)=min(LB(t−1), C(t)−d) Equation 7

UB(t)=max(UB(t−1), C(t)+d) Equation 8

Process 700 then transitions to decision block 812, wherein the upper bound UB(t) is compared to the lower bound LB(t). If UB(t) is greater than LB(t), process 800 transitions to block 808 and the process is repeated until UB(t) is not greater than LB(t). At that point, process 800 transitions to block 814, wherein the frame index t is compared to the total number of frames in the video. If the number of frames t is less than the total number of video frames, process 800 transitions to block 816, wherein the piecewise linear constant function is defined as L(ⱼ)=t−1 and the piecewise function index j is increased by one. Process 800 then transitions to block 806 and the process is repeated until the frame index equals the total number of frames of the video. When the frame index and the total number of video frames are equal, process 800 transitions to block 818, where the smooth camera path P(t) may be calculated as:

P(t)=[UB(L(j))+LB(L(j))]/2 Equation 9

where

L(j)≦t≦L(j+1)

Next, in block 820, the adjacent piecewise constant camer motion paths are connected with a linear function. The linear function may be computed as:

P(t)=k*t+b, Equation 10

where

k=[(UB(L(j+1))+LB(L(j+1)))/2−(UB(L(j))+LB(L(j)))/2]/[(L(j+2)−L(j))/2] Equation 11

b=(UB(L(j))+LB(L(j)))/2−k(L(j)+L(j+1))/2 Equation 12

and

[L(j)+L(j+1)]/2≦t≦[L(j+1)+L(j+2)]/2 Equation 13

Once the linear function that connects the adjacent constant camera paths is computed, process 800 transitions to block 822 and ends.

### Clarifications Regarding Terminology

Those having skill in the art will further appreciate that the various illustrative logical blocks, modules, circuits, and process blocks described in connection with the implementations disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The blocks of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such that the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A system for processing video images, comprising:
a camera configured to capture raw video composed of a series of successive image frames of a scene of interest; and
a processor configured to receive the image frames, estimate a global camera motion from successive frames, stabilize the camera motion by establishing an upper bound and a lower bound of the global camera motion and smooth a curve of the camera motion between the upper and lower bounds, and upsample the resulting stabilized video frames.

2. The system of claim 1, wherein the processor is further configured to stabilize the camera motion by cropping each video image frame by a specified height and width to determine the upper bound and the lower bound of the global camera motion.

3. The system of claim 2, wherein each video image frame is cropped by approximately 10%.

4. The system of claim 1, wherein the processor is further configured to estimate a global camera motion by extracting common features from the series of images, correlating the features in the series of images, and estimating a global camera motion by tracking the movement of the features by accumulating pairwise global motion vectors.

5. The system of claim 1, wherein the processor is further configured to estimate a global camera motion by determining block motion vectors between successive frames.

6. A method for processing video images, comprising:
receiving raw video composed of a series of successive image frames of a scene of interest;
estimating a global camera motion from successive frames;
establishing an upper and lower bound of the global camera motion by applying a cropping window to a first frame;
smoothing the curve of camera motion between the upper and lower bound to obtain a smooth camera path;
applying the cropping window to successive frames along the smooth camera path to obtain stabilized image frames; and
upsampling the resulting stabilized image frames.

7. The method of claim 6, wherein establishing an upper and lower bound comprises cropping each video image frame by a specified height and width.

8. The method of claim 6, wherein smoothing the curve of camera motion further comprises computing constant linear functions and piecewise linear functions that approximate the camera motion.

9. The method of claim 6, wherein estimating a global camera motion further comprises determining block motion vectors between successive frames.

10. The method of claim 6, wherein estimating a global camera motion further comprises extracting common features from the series of images, correlating the features in the series of images, and estimating a global camera motion by tracking the movement of the features by accumulating pairwise global motion vectors.

11. The method of claim 10, wherein extracting common features further comprises one of Shi Tomasi feature, Harris corner, SIFT, and SURF approaches.

12. The method of claim 10, wherein correlating the features further comprises one of Lucas-Kanade, Horn-Schunck, Buxton-Buxton, and Black-Jepson approaches.

13. The method of claim 10, wherein accumulating pairwise global motion vectors further comprises performing an optical flow method to track the features from the series of images to collect corresponding feature pairs.

14. An apparatus for processing video images, comprising:
means for capturing raw video composed of a series of successive image frames of a scene of interest;
means for estimating a global camera motion from successive frames;
means for establishing an upper and lower bound of the global camera motion by applying a cropping window to a first frame;
means for smoothing the curve of camera motion between the upper and lower bound to obtain a smooth camera path;
means for applying the cropping window to successive frames along the smooth camera path to obtain stabilized image frames; and
means for upsampling the resulting stabilized image frames.

15. A system for processing video images, comprising:
a camera configured to capture raw video composed of a series of successive image frames of a scene of interest; and
a control module configured to:
receive the raw video image frames;
estimate a global camera motion from successive frames by extracting common features from the series of images, correlating the features in the series of images, and estimating a global camera motion by tracking the movement of the features by accumulating pairwise global motion vectors;
stabilize the camera motion by establishing an upper bound and a lower bound of the global camera motion and smoothing the curve of camera motion between the upper and lower bounds; and
upsample the resulting stabilized video frames.

16. A non-transitory, computer readable medium, comprising instructions that when executed by a processor cause the processor to perform a method of processing video images, the method comprising:
receiving raw video composed of a series of successive image frames of a scene of interest;
estimating a global camera motion from successive frames;
establishing an upper and lower bound of the global camera motion by applying a cropping window to a first frame;
smoothing the curve of camera motion between the upper and lower bound to obtain a smooth camera path;
applying the cropping window to successive frames along the smooth camera path to obtain stabilized image frames; and
upsampling the resulting stabilized image frames.

17. The computer readable medium of claim 16, wherein establishing an upper and lower bound comprises cropping each video image frame by a specified height and width.

18. The computer readable medium of claim 16, wherein smoothing the curve of camera motion further comprises computing constant linear functions and piecewise linear functions that approximate the camera motion.

19. The computer readable medium of claim 16, wherein estimating a global camera motion further comprises extracting common features from the series of images, correlating the features in the series of images, and estimating a global camera motion by tracking the movement of the features by accumulating pairwise global motion vectors.

20. The computer readable medium of claim 16, wherein extracting common features further comprises one of Shi Tomasi feature, Harris corner, SIFT, and SURF approaches.

21. The computer readable medium of claim 16, wherein correlating the features further comprises one of Lucas-Kanade, Horn-Schunck, Buxton-Buxton, and Black-Jepson approaches.

22. The computer readable medium of claim 19, wherein accumulating pairwise global motion vectors further comprises performing an optical flow method to track the features from the series of images to collect corresponding feature pairs.

23. The computer readable medium of claim 16, wherein estimating a global camera motion further comprises determining block motion vectors between successive frames.
